(19) United States
(12) Patent Application Publication
(10) Pub. No.: US 2009/0284131 A1
(43) Pub. Date: Nov. 19, 2009

(54) Display device and associated methods

(76) Inventor: Young-Gil Yoo, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/385,776

(22) Filed: Apr. 20, 2009

(30) Foreign Application Priority Data
May 13, 2008 (KR) 10-2008-0043949

(51) Int. Cl. H01J 1/62; H01J 9/00

(52) U.S. Cl. 313/503; 313/505; 445/24

(57) ABSTRACT

A display device and associated methods, the display device including a first substrate and a second substrate arranged opposite to each other, a plurality of address electrodes disposed on the first substrate, a plurality of display electrodes disposed on the second substrate in a direction crossing the address electrodes, and red, green, and blue phosphor layers disposed in a discharge space between the first and second substrates, wherein the red phosphor layer includes a red phosphor and SiO₂.

### BACKGROUND

1. Technical Field

Embodiments relate to a display device and associated methods.

2. Description of the Related Art

A plasma display panel (PDP) is a display device that forms an image by exciting phosphors with, e.g., vacuum ultraviolet (VUV) rays generated by gas discharge in discharge cells. Since a PDP may be capable of forming a large, high-resolution screen, it is drawing attention as a next-generation thin display device.

A PDP may include address electrodes disposed in a first direction on a rear substrate and a dielectric layer covering the address electrodes. Barrier ribs may be formed on the dielectric layer in, e.g., a stripe pattern, and red (R), green (G), and blue (B) phosphor layers may be positioned on the discharge cells between the barrier ribs.

On a surface of a front substrate, display electrodes may be formed in pairs in a direction crossing the address electrodes. A pair of display electrodes may include a transparent electrode and a bus electrode. Dielectric and protection layers may be formed on the front substrate and cover the display electrodes. Discharge cells may be formed at the intersection of the address electrodes on the rear substrate and the display electrodes on the front substrate.

The PDP may be driven by applying an address voltage (Va) between address electrodes and display electrodes to achieve an address discharge. A sustain voltage (Vs) may be applied to a pair of display electrodes to achieve a sustain discharge. The excitation source may excite corresponding phosphor layers to emit visible light through the transparent front substrate, so the PDP may realize images. As the excitation source, VUV rays may generally be used.

The phosphor layer may be formed by using red, green, and blue phosphors. Each phosphor may generate visible light by, e.g., Xe ion resonance radiation (147 nm VUV rays).

The phosphor layers for plasma displays have been researched with regard to improving the fluorescent material for a known phosphor application, e.g., for a cathode ray tube (CRT). In order to utilize the phosphor layer in the PDP, the light emitting luminance, luminous efficiency, and color purity should be excellent, the afterglow time should be short, and particularly the phosphor layer should not deteriorate due to heat or ultraviolet light.

Generally, a PDP may use phosphor layers including a phosphor such as Y(V,P)O₄:Eu as a red phosphor, a phosphor such as Zn₂SiO₄:Mn as a green phosphor, and a phosphor such as BaMgAl₁₀O₁₇:Eu as a blue phosphor. However, the red, green, and blue phosphor layers for the PDP may have different luminance deterioration rates from each other, depending on their age. Accordingly, the white color temperature of a PDP may tend to decrease over time. In addition, stains and permanent after-images may be generated due to a localized decrease of the white color temperature.

In particular, these problems may be caused because the luminance deterioration ratio of the red phosphor layer may be lower than those of the green or the blue phosphor layer. Thus, it may be desirable to have the luminance deterioration ratios of the red, green, and blue phosphor layers as close as possible.

### SUMMARY

Embodiments are therefore directed to a display device and associated methods, which substantially overcome the problems due to the limitations and disadvantages of the related art.

It is therefore a feature of an embodiment to provide a display device having excellent white color temperature.

It is therefore another feature of an embodiment to provide a display device having excellent lifespan characteristics.

At least one of the above and other features and advantages may be realized by providing a display device, including a first substrate and a second substrate arranged opposite to each other, a plurality of address electrodes disposed on the first substrate, a plurality of display electrodes disposed on the second substrate in a direction crossing the address electrodes, and red, green, and blue phosphor layers disposed in a discharge space between the first and second substrates. The red phosphor layer may include a red phosphor and SiO₂.

The red phosphor may include at least one of Y₂O₂S:Eu, (Y,Gd)BO₃:Eu, Y(P,V)O₄:Eu, Y₂O₃:Eu, YAl₃(BO₃)₄:Eu, and (Y,Gd)₂O₃:Eu.

The red phosphor may include at least one of (Y,Gd)BO₃:Eu, Y(P,V)O₄:Eu, and Y₂O₃:Eu.

The SiO₂ may be included in an amount of about 0.01 wt. % to about 5 wt. % based on the total weight of the red phosphor layer.

The SiO₂ may be included in an amount of about 0.1 wt. % to about 1 wt. % based on the total weight of the red phosphor layer.

The SiO₂ may have an average particle diameter of about 10 nm to about 100 nm.

The red phosphor layer may further include a metal element including at least one of an alkali metal and an alkaline-earth metal.

The metal element may include at least one of sodium, calcium, and potassium.

The metal element may be included in an amount of about 0.01 wt. % to about 5 wt. % based on the total weight of the red phosphor layer.

At least one of the above and other features and advantages may also be realized by providing a method of manufacturing a display device, including forming a plurality of address electrodes on a first substrate, forming a plurality of display electrodes on a second substrate in a direction crossing the address electrodes, forming red, green, and blue phosphor layers in a discharge space between the first and second substrates, wherein the red phosphor layer includes a red phosphor and SiO₂, and arranging the first substrate and the second substrate opposite to each other.

The red phosphor may include at least one of Y₂O₂S:Eu, (Y,Gd)BO₃:Eu, Y(P,V)O₄:Eu, Y₂O₃:Eu, YAl₃(BO₃)₄:Eu, and (Y,Gd)₂O₃:Eu.

The red phosphor may include at least one of (Y,Gd)BO₃:Eu, Y(P,V)O₄:Eu, and Y₂O₃:Eu.

The SiO₂ may be included in an amount of about 0.01 wt. % to about 5 wt. % based on the total weight of the red phosphor layer.

The SiO₂ may be included in an amount of about 0.1 wt. % to about 1 wt. % based on the total weight of the red phosphor layer.

The SiO₂ may have an average particle diameter of about 10 nm to about 100 nm.

The red phosphor layer may further include a metal element including at least one of an alkali metal and an alkaline-earth metal.

The metal element may include at least one of sodium, calcium, and potassium.

The metal element may be included in an amount of about 0.01 wt. % to about 5 wt. % based on the total weight of the red phosphor layer.

Forming the red phosphor layer may include at least one of mixing the SiO₂ with the red phosphor before forming the red phosphor layer or depositing the red phosphor and coating the SiO₂ on the deposited red phosphor.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a partial exploded perspective view of a PDP according to an embodiment;

FIG. 2 illustrates a graph of a luminance maintaining ratio over time of red, green, and blue phosphor layers of a PDP prepared according to Comparative Example 1;

FIG. 3 illustrates a graph of a luminance maintaining ratio over time of red, green, and blue phosphor layers of a PDP prepared according to Example 1;

FIG. 4 illustrates a graph of a white color temperature maintaining ratio over time of PDPs prepared according to Comparative Example 1 and Example 4; and

FIG. 5 illustrates a graph of a white color temperature maintaining ratio of PDPs prepared according to Examples 3 to 5 and Comparative Example 1.

### DETAILED DESCRIPTION

Korean Patent Application No. 10-2008-0043949, filed on May 13, 2008, in the Korean Intellectual Property Office, and entitled: “PLASMA DISPLAY PANEL,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B, and C together, whereas the expression “either A, B, or C” means one of A alone, B alone, and C alone, and does not mean any of both A and B together; both A and C together; both B and C together; and all three of A, B, and C together.

As used herein, the terms “a” and “an” are open terms that may be used in conjunction with singular items or with plural items. For example, the term “an alkali metal” may represent a single compound, e.g., sodium, or multiple compounds in combination, e.g., sodium mixed with potassium.

As used herein, the language “parts by weight, based on the total amount of the composition” is exclusive of solvent, unless otherwise indicated. That is, as used herein, the point of reference “the total amount of the composition” does not include solvent. For example, where a composition is composed of two components A and B, with A present in 35 parts by weight and B present in 65 parts by weight, based on the total amount of the composition, the addition of 10 parts by weight of solvent to the composition would result in the composition continuing to have 35 parts by weight A and 65 parts by weight B, based on the total amount of the composition.

Embodiments relate to a display device. The display device may include a PDP. A PDP according to an embodiment may include a first substrate and a second substrate arranged opposite to each other, a plurality of address electrodes disposed on the first substrate, a plurality of display electrodes disposed on a side of the second substrate in a direction crossing the address electrodes, and red, green, and blue phosphor layers disposed in discharge space between the first and second substrates.

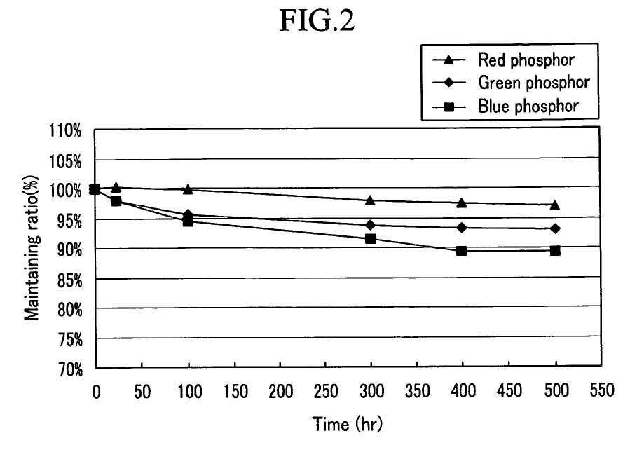

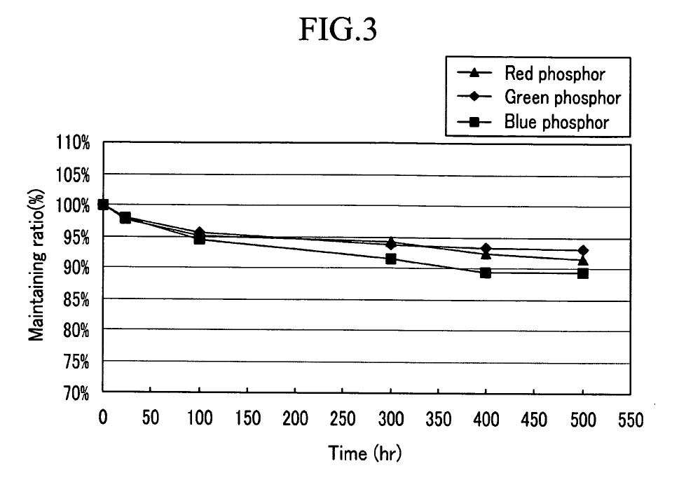

The red phosphor layer may include a red phosphor and SiO₂. The SiO₂ may beneficially decrease the luminance maintaining ratio of the red phosphor layer when it is added to the red phosphor. Accordingly, the luminance maintaining ratio of the red phosphor layer may be decreased to match that of the green and/or blue phosphor layers, i.e., the luminance of each of the red, green, and blue phosphor layers may be adjusted to be substantially similar to one another. For example, as described in detail below, a red phosphor layer including SiO₂ according to an embodiment, e.g., as shown in FIG. 3, may have a reduced luminance maintaining ratio at 100 to 500 hours relative to a comparative red phosphor layer, e.g., as shown in FIG. 2, containing no SiO₂. Accordingly, a PDP including the red phosphor layer of an embodiment may exhibit improved white color temperature, even as the phosphor layers age, so the lifespan of the PDP may be improved.

The SiO₂ may, e.g., be added together with the red phosphor to be present in the red phosphor layer, or the SiO₂ may be added by being coated on the surface of the red phosphor. The red phosphor is not specifically limited, but it may include any suitable red phosphor used in a conventional PDP. Specific examples of the red phosphor may include, e.g., Y₂O₂S:Eu, (Y,Gd)BO₃:Eu, Y(P,V)O₄:Eu, Y₂O₃:Eu, YAl₃ BO₃₄:Eu, and (Y,Gd)₂O₃:Eu,.

In an embodiment, the red phosphor may include at least one of (Y,Gd)BO₃:Eu, Y(P,V)O₄:Eu, and Y₂O₃:Eu. These phosphors may be desirable because the (Y,Gd)BO₃:Eu, Y(P,V)O₄:Eu, or Y₂O₃:Eu may emit light having a wavelength of 580 nm or more, and the SiO₂ may effectively decrease the lifespan of the phosphor layer having this wavelength band.

In an embodiment, the amount of SiO₂ may be about 0.01 wt. % to about 5 wt. %, based on the total weight of the red phosphor layer. Preferably, the amount of SiO₂ is about 0.1 wt. % to about 1 wt. %. Maintaining the amount of SiO₂ at about 0.01 wt. % to about 5 wt. % may help ensure that the luminance maintaining ratio of the red phosphor layer is similar to that of the green phosphor layer and/or blue phosphor layer, thereby providing a PDP with a consistent white color temperature over time.

The SiO₂ may have an average particle diameter of about 10 nm to about 100 nm. Maintaining the average particle diameter of the SiO₂ within these amounts may help ensure that an undesirable luminance reduction is minimized.

The red phosphor layer may further include a metal element including, e.g., an alkali metal (Group IA metal), an alkaline-earth metal (Group IIA metal), and mixtures thereof. When the metal element is included in a red phosphor layer together with SiO₂, it may beneficially increase the effects of adding the SiO₂. The metal element may include at least one of sodium, calcium, and potassium. Preferably, the metal element includes sodium.

The metal element may be included in an amount of about 0.01 wt. % to about 5 wt. % based on the total weight of the red phosphor layer. Maintaining the amount of the metal element within these amounts may help ensure that the luminance maintaining ratio of the red phosphor layer is similar to that of the green phosphor layer or blue phosphor layer, and the PDP maintains an ideal white color temperature over time.

Embodiments will now be described more fully hereinafter with reference to the accompanying drawings, in which preferred embodiments are shown. As those skilled in the art would realize, the described embodiments may be modified in various different ways, all without departing from the spirit or scope.

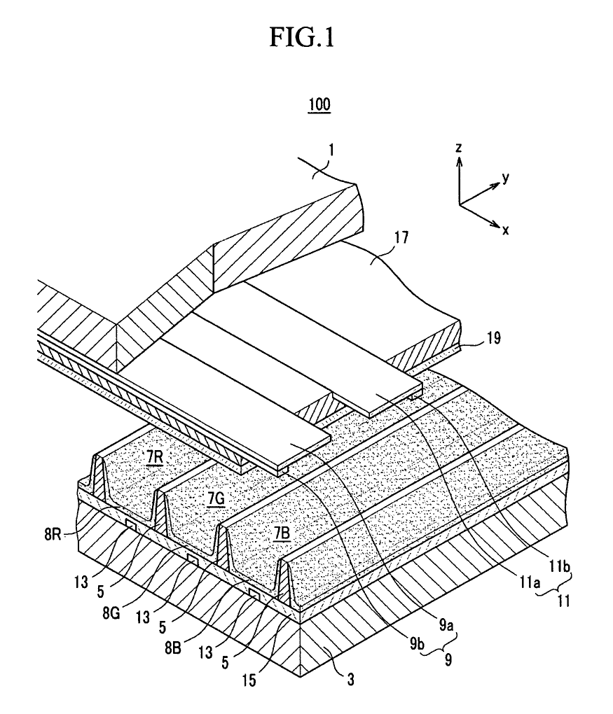

FIG. 1 illustrates a partial exploded perspective view showing a PDP 100 according to an embodiment. Referring to the drawing, the PDP 100 may include a first substrate 3, a plurality of address electrodes 13 disposed in a first direction (a Y direction in the drawing) on the first substrate 3, and a dielectric layer 15 disposed on the surface of the first substrate 3 covering the address electrodes 13. Barrier ribs 5 may be formed on the dielectric layer 15, and red (R), green (G), and blue (B) phosphor layers 8R, 8G, and 8B may be disposed in discharge cells 7R, 7G, and 7B formed between the barrier ribs 5. The red phosphor layer 8R may include a red phosphor and SiO₂.

The barrier ribs 5 may be formed in any suitable shape to partition a discharge space. In addition, the barrier ribs 5 may have diverse patterns. For example, the barrier ribs 5 may be formed as an open type, e.g., stripes, or as a closed type, e.g., a waffle, a matrix, or a delta shape. Also, the closed-type barrier ribs may be formed such that a horizontal cross-section of the discharge space is a polygon, e.g., a quadrangle, a triangle, or a pentagon, or a circle or an oval.

Display electrodes 9 and 11, each including a pair of transparent electrodes 9a and 11a and bus electrodes 9b and 11b, may be disposed in a second direction crossing the address electrodes 13 (an X direction in the drawing) on a surface of a second substrate 1 facing the first substrate 3. Also, a dielectric layer 17 and a protective layer 19 may be disposed on the surface of the second substrate 1, while covering the display electrodes 9 and 11. Discharge cells may be formed at positions where the address electrodes 13 of the first substrate 3 cross the display electrodes 9 and 11 of the second substrate 1.

In the PDP, address discharge may be achieved by applying an address voltage (Va) to a space between the address electrodes 13 and the display electrodes 9 and 11. When a sustain voltage (Vs) is applied between a pair of display electrodes 9 and 11, an excitation source generated from the sustain discharge may excite a corresponding phosphor layer to thereby emit visible light through the second substrate 1, and display an image. The phosphor layers may be excited by VUV rays.

The following examples illustrate the embodiments in more detail. However, it is understood that the embodiments are not limited by these examples.

Manufacturing a PDP

### EXAMPLE 1

6 parts by weight of an ethyl cellulose binder was added to 100 parts by weight of a mixed solvent in which butyl carbitol acetate and terpineol were mixed at a weight ratio of 3:7. Then, 40 parts by weight of red phosphor (Y,Gd)BO₃:Eu powder, and an amount of SiO₂ that was calculated to be 0.1 wt. % based on the total weight of red phosphor layer were added thereto to provide a red phosphor paste.

The red phosphor paste was coated on the inside of discharge cells of a first substrate having barrier ribs. The first substrate coated with the red phosphor paste was dried and baked to provide a red phosphor layer.

Green and blue phosphor layers were prepared by using Zn₂SiO₄:Mn and CaMgSi₂O₆:Eu phosphors to provide green and blue discharge cells, respectively. The first substrate having the red, green, and blue phosphor layers and the second substrate having the display electrodes were subjected to steps of assembling, sealing, degassing, injecting, and aging to provide a PDP.

### EXAMPLE 2

A PDP was manufactured in accordance with the same procedure as in Example 1, except that the red phosphor paste was prepared by adding SiO₂ in an amount that was calculated to be 0.3 wt. % based on the total weight of the red phosphor layer.

### EXAMPLE 3

A PDP was manufactured in accordance with the same procedure as in Example 1, except that the red phosphor paste was prepared by adding SiO₂ in an amount that was calculated to be 0.5 wt. % based on the total weight of the red phosphor layer.

### EXAMPLE 4

A PDP was manufactured in accordance with the same procedure as in Example 1, except that the red phosphor paste was prepared by adding SiO₂ in an amount that was calculated to be 1 wt. % based on the total weight of the red phosphor layer.

### EXAMPLE 5

A PDP was manufactured in accordance with the same procedure as in Example 1, except that the red phosphor paste was prepared by adding SiO₂ in an amount that was calculated to be 2 wt. % based on the total weight of the red phosphor layer.

### EXAMPLE 6

A PDP was manufactured in accordance with the same procedure as in Example 1, except that Y(P,V)O₄:Eu was used as the red phosphor instead of (Y,Gd)BO₃:Eu.

### EXAMPLE 7

A PDP was manufactured in accordance with the same procedure as in Example 2, except that Y(P,V)O₄:Eu was used as the red phosphor instead of (Y,Gd)BO₃:Eu.

### EXAMPLE 8

A PDP was manufactured in accordance with the same procedure as in Example 3, except that Y(P,V)O₄:Eu was used as the red phosphor instead of (Y,Gd)BO₃:Eu.

### EXAMPLE 9

A PDP was manufactured in accordance with the same procedure as in Example 4, except that Y(P,V)O₄:Eu was used as the red phosphor instead of (Y,Gd)BO₃:Eu.

### EXAMPLE 10

A PDP was manufactured in accordance with the same procedure as in Example 5, except that Y(P,V)O₄:Eu was used as the red phosphor instead of (Y,Gd)BO₃:Eu.

### COMPARATIVE EXAMPLE 1

A PDP was manufactured in accordance with the same procedure as in Example 1, except that the red phosphor paste was prepared without adding SiO₂.

### COMPARATIVE EXAMPLE 2

A PDP was manufactured in accordance with the same procedure as in Example 5, except that the red phosphor paste was prepared without adding SiO₂.

Luminance Maintaining Ratio of the PDP

The PDPs prepared according to Examples 1 to 10, Comparative Example 1, and Comparative Example 2 were measured to determine the baseline luminance of the red light by using a contact luminance meter (Minolta, CA-100™). In addition, the PDPs were measured to determine the luminance maintaining ratio and the white color temperature maintaining ratio over time. The measurement results are shown in FIGS. 2 to 4.

FIG. 2 illustrates the luminance maintaining ratio over time of red, green, and blue phosphor layers of a PDP prepared according to Comparative Example 1. As shown in FIG. 2, the luminance maintaining ratios of the red, green, and blue phosphor layers were similar to each other in the early stage, but diverged over time. Particularly, it is understood that the luminance maintaining ratio of the red phosphor layer was remarkably higher relative to that of the blue or green phosphor layers.

FIG. 3 illustrates the luminance maintaining ratio over time of red, green, and blue phosphor layers in the PDP prepared according to Example 1. Referring to FIG. 3, it is understood that the PDP prepared according to Example 1 had negligible difference in the luminance maintaining ratio of red, green, and blue phosphor layers even after 500 hours.

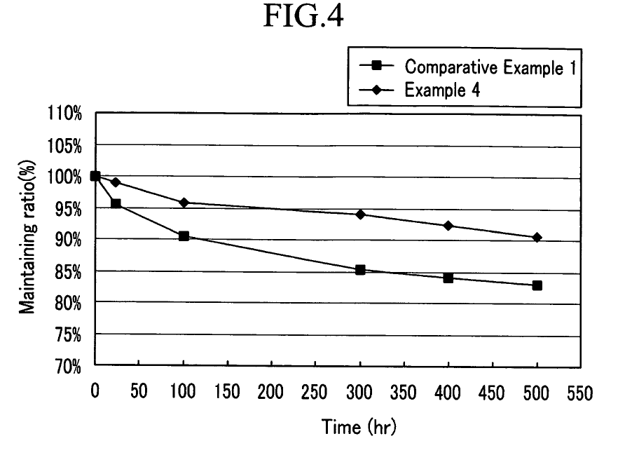

FIG. 4 illustrates a white color temperature maintaining ratio of PDPs prepared according to Comparative Example 1 and Example 4. Referring to FIG. 4, it is confirmed that the PDP prepared according to Example 4 had a remarkably superior white color temperature maintaining ratio after 500 hours relative to that of the PDP prepared according to Comparative Example 1. The PDP prepared according to Example 4 had luminance maintaining ratios of the red, green, and blue phosphor layers that were similar to each other.

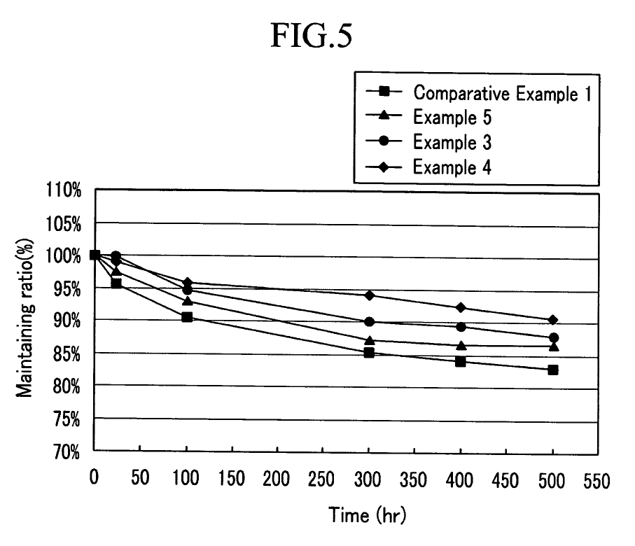

FIG. 5 shows a white color temperature maintaining ratio of PDPs according to Examples 3 to 5 and Comparative Example 1. Referring to FIG. 5, Example 4 had the best white color temperature maintaining ratio.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display device, comprising:
a first substrate and a second substrate arranged opposite to each other;
a plurality of address electrodes disposed on the first substrate;
a plurality of display electrodes disposed on the second substrate in a direction crossing the address electrodes; and
red, green, and blue phosphor layers disposed in a discharge space between the first and second substrates, wherein the red phosphor layer includes a red phosphor and SiO₂.

2. The display device as claimed in claim 1, wherein the red phosphor includes at least one of Y₂O₂S:Eu, (Y,Gd)BO₃:Eu, Y(P,V)O₄:Eu, Y₂O₃:Eu, YAl₃(BO₃)₄:Eu, and (Y,Gd)₂O₃:Eu.

3. The display device as claimed in claim 2, wherein the red phosphor includes at least one of (Y,Gd)BO₃:Eu, Y(P,V)O₄:Eu, and Y₂O₃:Eu.

4. The display device as claimed in claim 1, wherein the SiO₂ is included in an amount of about 0.01 wt. % to about 5 wt. % based on the total weight of the red phosphor layer.

5. The display device as claimed in claim 4, wherein the SiO₂ is included in an amount of about 0.1 wt. % to about 1 wt. % based on the total weight of the red phosphor layer.

6. The display device as claimed in claim 1, wherein the SiO₂ has an average particle diameter of about 10 nm to about 100 nm.

7. The display device as claimed in claim 1, wherein the red phosphor layer further includes a metal element including at least one of an alkali metal and an alkaline-earth metal.

8. The display device as claimed in claim 7, wherein the metal element includes at least one of sodium, calcium, and potassium.

9. The display device as claimed in claim 7, wherein the metal element is included in an amount of about 0.01 wt. % to about 5 wt. % based on the total weight of the red phosphor layer.

10. A method of manufacturing a display device, comprising:
forming a plurality of address electrodes on a first substrate;
forming a plurality of display electrodes on a second substrate in a direction crossing the address electrodes;
forming red, green, and blue phosphor layers in a discharge space between the first and second substrates, wherein the red phosphor layer includes a red phosphor and SiO₂; and
arranging the first substrate and the second substrate opposite to each other.

11. The method of manufacturing a display device as claimed in claim 10, wherein the red phosphor includes at least one of Y₂O₂S:Eu, (Y,Gd)BO₃:Eu, Y(P,V)O₄:Eu, Y₂O₃:Eu, YAl₃(BO₃)₄:Eu, and (Y,Gd)₂O₃:Eu.

12. The method of manufacturing a display device as claimed in claim 11, wherein the red phosphor includes at least one of (Y,Gd)BO₃:Eu, Y(P,V)O₄:Eu, and Y₂O₃:Eu.

13. The method of manufacturing a display device as claimed in claim 10, wherein the SiO₂ is included in an amount of about 0.01 wt. % to about 5 wt. % based on the total weight of the red phosphor layer.

14. The method of manufacturing a display device as claimed in claim 13, wherein the SiO₂ is included in an amount of about 0.1 wt. % to about 1 wt. % based on the total weight of the red phosphor layer.

15. The method of manufacturing a display device as claimed in claim 10, wherein the SiO₂ has an average particle diameter of about 10 nm to about 100 nm.

16. The method of manufacturing a display device as claimed in claim 10, wherein the red phosphor layer further includes a metal element including at least one of an alkali metal and an alkaline-earth metal.

17. The method of manufacturing a display device as claimed in claim 16, wherein the metal element includes at least one of sodium, calcium, and potassium.

18. The method of manufacturing a display device as claimed in claim 16, wherein the metal element is included in an amount of about 0.01 wt. % to about 5 wt. % based on the total weight of the red phosphor layer.

19. The method of manufacturing a display device as claimed in claim 10, wherein forming the red phosphor layer includes at least one of mixing the SiO₂ with the red phosphor before forming the red phosphor layer or depositing the red phosphor and coating the SiO₂ on the deposited red phosphor.
